(19) United States
(12) Patent Application Publication
(10) Pub. No.: US 2025/0162199 A1
(43) Pub. Date: May 22, 2025

(54) FULLY-AUTOMATIC MULTI-STATION CUTTING MACHINE AND METHOD FOR CUTTING MATERIAL

(71) Applicant: Fujian Skystone Intelligent Equipment Co., Ltd., Putian (CN)

(72) Inventors: Haiwei LI, Putian (CN); Bo LI, Putian (CN); Huaying YANG, Putian (CN); Huihua YU, Putian (CN); Zhouchen LIN, Putian (CN); Dejing HE, Putian (CN); Junguang ZHONG, Putian (CN); Yian SONG, Putian (CN)

(73) Assignee: Fujian Skystone Intelligent Equipment Co., Ltd., Putian (CN)

(21) Appl. No.: 18/533,689

(22) Filed: Dec. 8, 2023

(30) Foreign Application Priority Data
Nov. 16, 2023 (CN) 202311528000.4

(51) Int. Cl. B28D 5/00; B28D 5/04

(52) U.S. Cl. CPC B28D 5/0082; B28D 5/045

(57) ABSTRACT

Disclosed are a fully-automatic multi-station cutting machine and a method for cutting a material. The fully-automatic multi-station cutting machine includes a conveying assembly, a cutting assembly, transfer assemblies and a receiving assembly; the cutting assembly is located on one side of a length direction of the conveying assembly; the transfer assemblies and the receiving assembly are located on the other side of the length direction of the conveying assembly; and the transfer assemblies are capable of reciprocating in length and width directions of the conveying assembly. After being conveyed to a specified position by the conveying assembly, a material can be uniformly cut into a plurality of segments by the cutting assembly. After the cutting is ended, a head or tail material is taken out of the conveying assembly and is transferred to the receiving assembly by the transfer assemblies.

### CROSS-REFERENCE TO RELATED APPLICATIONS

This application claims priority to Chinese Patent Application No. 202311528000.4, filed on Nov. 16, 2023, the content of which is incorporated herein by reference in its entirety.

### TECHNICAL FIELD

The present disclosure belongs to the technical field of silicon rod processing equipment, in particular relates to a fully-automatic multi-station cutting machine and a method for cutting a material.

### BACKGROUND

In order to increase the cutting efficiency of silicon rods, a multi-station cutting machine is popular in the industry due to high efficiency and high processing precision. For example, a multi-station cutting machine disclosed by Chinese Patent Publication CN112536929A includes a feeding mechanism, a clamping mechanism, a cutting mechanism and a receiving mechanism; the feeding mechanism, the cutting mechanism and the receiving mechanism are sequentially arranged in a processing direction, the clamping mechanism is disposed below the cutting mechanism, and the clamping mechanism is used for clamping a hard and brittle rod; more than two supporting assemblies are sequentially arranged on a base in the processing direction, a gap allowing the cutting mechanism to pass through is disposed between the two adjacent supporting assemblies, a first power assembly is used for driving the supporting assemblies to relatively move along a slide rail and change a distance between the adjacent supporting assemblies; and a power unit is used for driving a lifting part to drive a cutting part to lift, so that the multi-station cutting machine can be used for cutting a hard and brittle rod with any length, and at the same time, a certain specified position of the hard and brittle rod can also be cut independently.

However, it was found during actual use that the multi-station cutting machine cannot automatically perform a dumping action on head and tail materials and has to complete the dumping for the head and tail materials in a manual dumping way which is not only low in efficiency, but also indirectly increases the labor cost and is not beneficial to transition to fully-automatic machining in a workshop.

### SUMMARY

The technical problem to be solved in the present disclosure is to provide a fully-automatic multi-station cutting machine capable of achieving automatic dumping.

In order to solve the above-mentioned technical problem, the present disclosure provides a fully-automatic multi-station cutting machine, including a conveying assembly, a cutting assembly, transfer assemblies and a receiving assembly; the cutting assembly being located on one side of a length direction of the conveying assembly; the transfer assemblies and the receiving assembly being located on the other side of the length direction of the conveying assembly; and the transfer assemblies being capable of reciprocating in length and width directions of the conveying assembly.

The other technical solution of the present disclosure is that: provided is a method for cutting a material by adopting the above-mentioned fully-automatic multi-station cutting machine, including the following steps:
S1, moving the material to an underface of the cutting assembly by the conveying assembly;
S2, after the cutting assembly moves to a specified cutting position, starting the cutting assembly to cut the material, and moving the transfer assemblies to an underface of a head or tail material;
S3, after the cutting is ended, transferring the head or tail material to the receiving assembly by the transfer assemblies, and resetting the cutting assembly; and
S4, withdrawing the head or tail material from the fully-automatic multi-station cutting machine by the receiving assembly to complete the cutting of the material.

The present disclosure has the beneficial effects that the fully-automatic multi-station cutting machine provided in the present disclosure is compact in structure and convenient to use. After being conveyed to a specified position by the conveying assembly, a material can be uniformly cut into a plurality of segments by the cutting assembly. After the cutting is ended, head and tail materials are taken out of the conveying assembly and are transferred to the receiving assembly by the transfer assemblies, finally, the head and tail materials are further withdrawn from the fully-automatic multi-station cutting machine by the receiving assembly, and thus, the fully-automatic cutting for the material can be completed.

### BRIEF DESCRIPTION OF THE DRAWINGS

FIG. 1 is a schematic structural diagram of a fully-automatic multi-station cutting machine in a specific implementation of the present disclosure.

FIG. 2 is a schematic structural diagram of another fully-automatic multi-station cutting machine in a specific implementation of the present disclosure.

FIG. 3 is a schematic structural diagram of a transfer assembly in a specific implementation of the present disclosure.

FIG. 4 is a schematic structural diagram of another angle of a transfer assembly in a specific implementation of the present disclosure.

FIG. 5 is a front view of a transfer assembly in a specific implementation of the present disclosure.

FIG. 6 is a schematic structural diagram of a receiving assembly in a specific implementation of the present disclosure.

FIG. 7 is a schematic structural diagram of a floating supporting member in a specific implementation of the present disclosure.

FIG. 8 is a schematic structural diagram of another transfer assembly in a specific implementation of the present disclosure.

FIG. 9 is an enlarged view of part A in FIG. 8.

FIG. 10 is a schematic structural diagram of another receiving assembly in a specific implementation of the present disclosure.

FIG. 11 is a schematic structural diagram of a lifting mechanism in a specific implementation of the present disclosure.

FIG. 12 is a front view of the lifting mechanism in a specific implementation of the present disclosure.

FIG. 13 is a schematic structural diagram of another lifting mechanism in a specific implementation of the present disclosure.

FIG. 14 is a right view of further lifting mechanism in a specific implementation of the present disclosure.

FIG. 15 illustrates a method for cutting a material by adopting the fully-automatic multi-station cutting machine.

### DETAILED DESCRIPTION OF THE EMBODIMENTS

In order to describe the technical content, achieved purpose and effect of the present disclosure in detail, description is shown below in conjunction with implementations and cooperation with accompanying drawings.

The most critical concept of the present disclosure lies in that: after being conveyed to a specified position by the conveying assembly, a material can be uniformly cut into a plurality of segments by the cutting assembly. After the cutting is ended, a head or tail material is taken out of the conveying assembly and is transferred to the receiving assembly by the transfer assemblies, finally, the head or tail material is further withdrawn from the fully-automatic multi-station cutting machine by the receiving assembly, and thus, the fully-automatic cutting for the material can be completed.

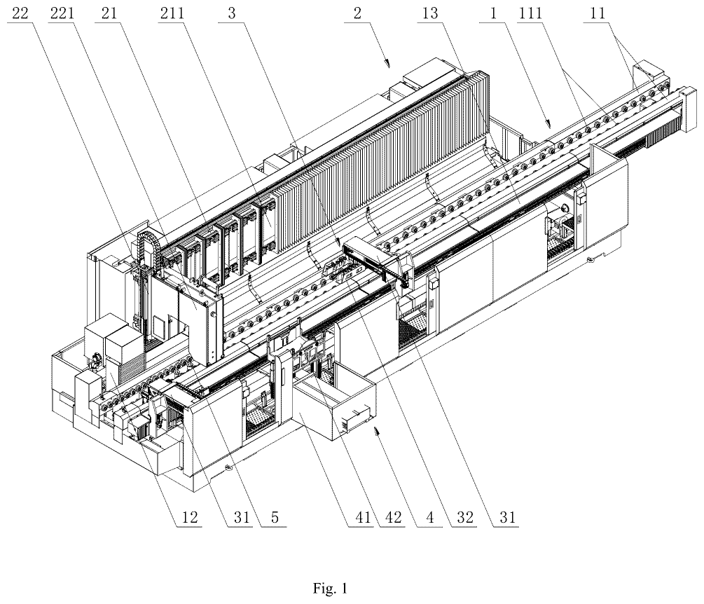

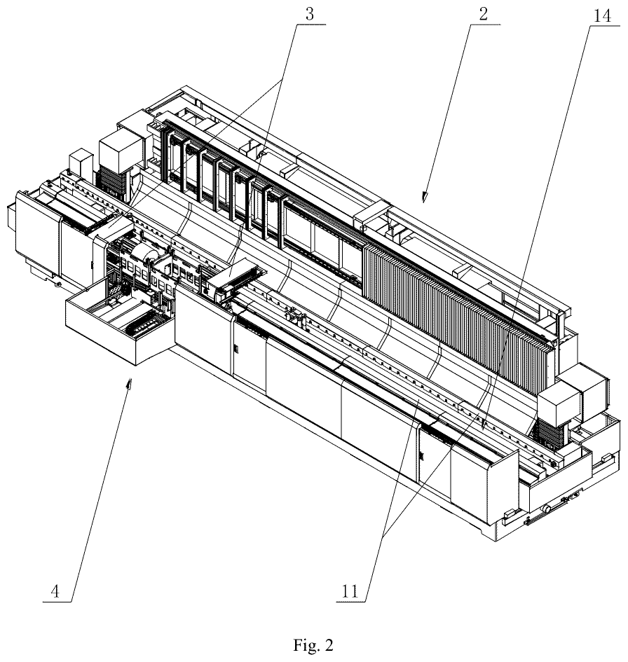

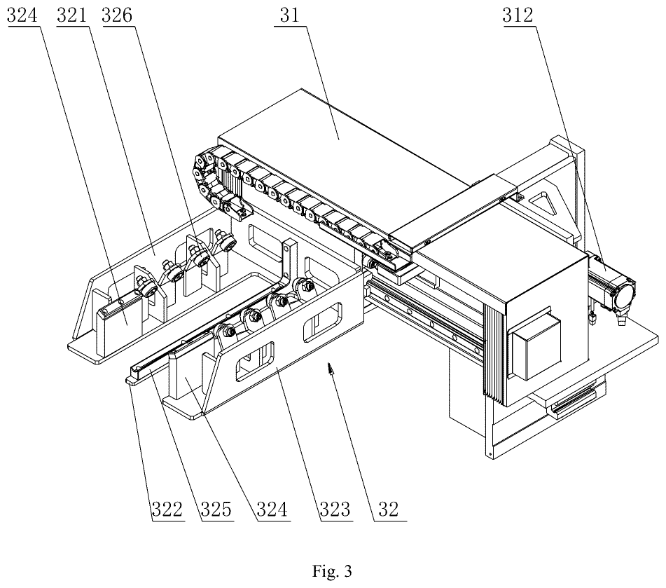

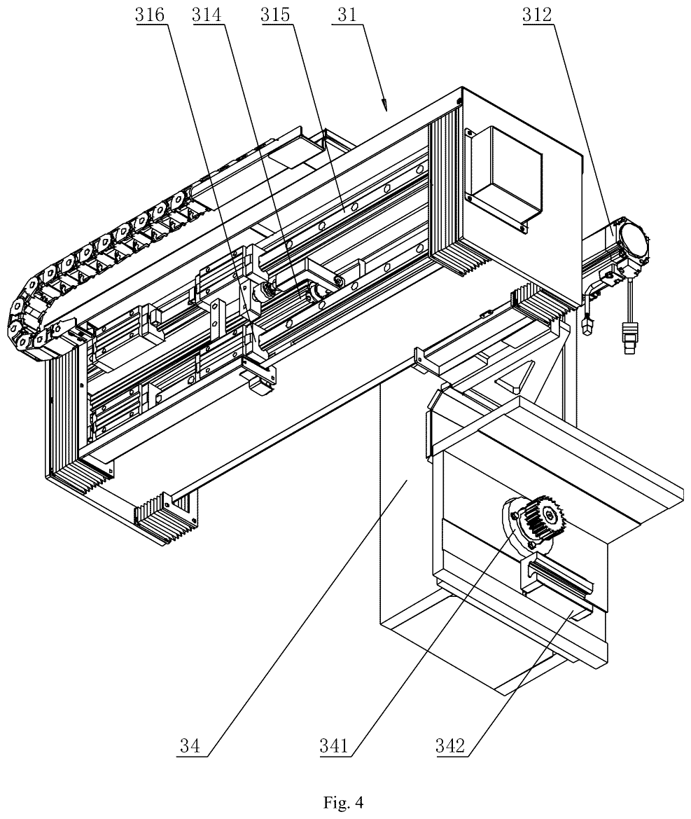

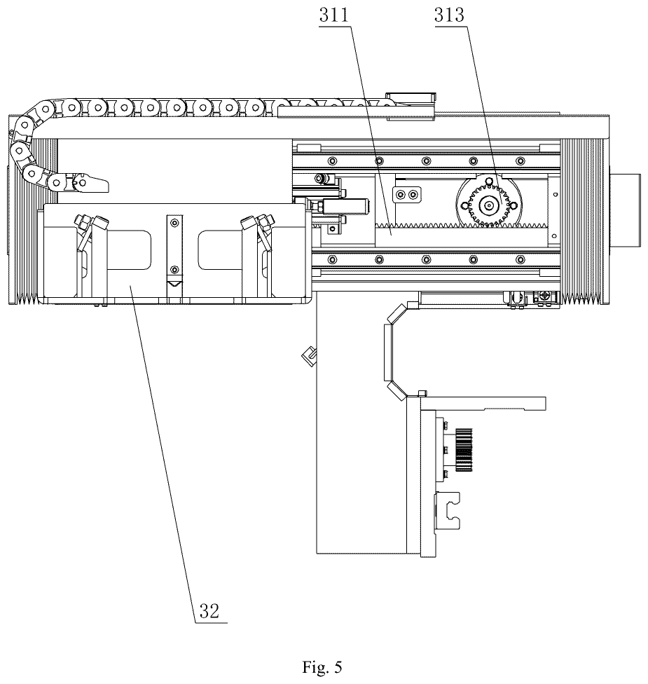

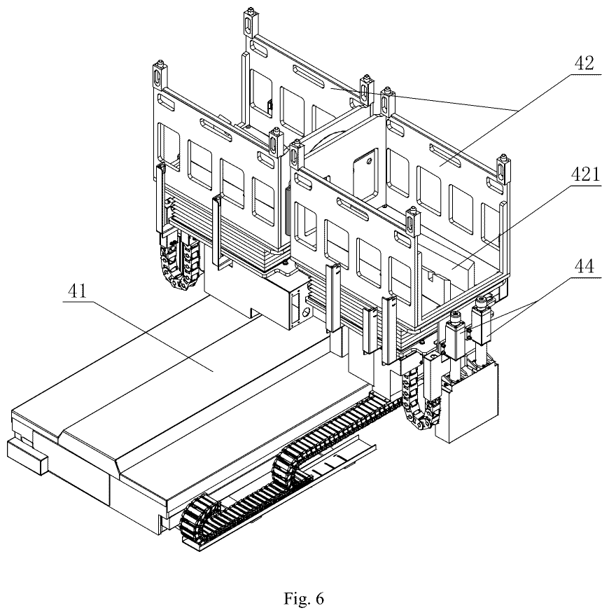

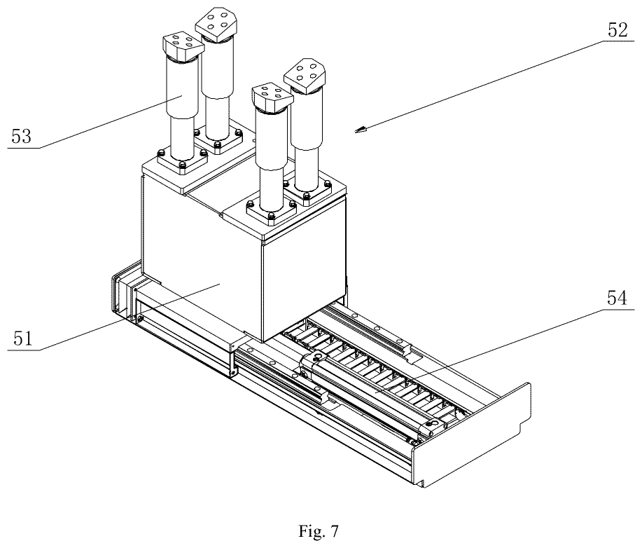

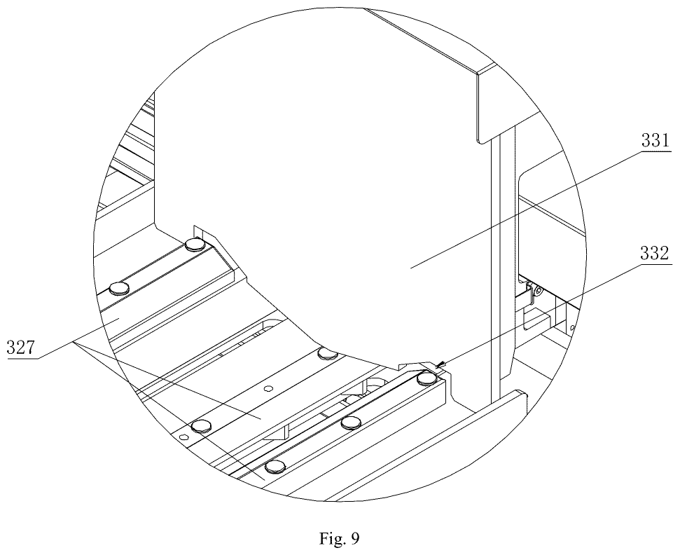

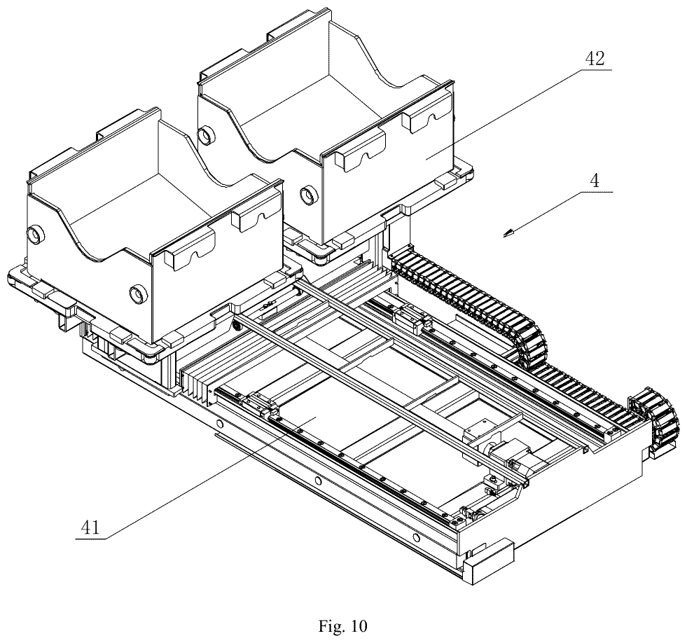

Please refer to FIG. 1 to FIG. 14, a fully-automatic multi-station cutting machine provided in the present disclosure includes a conveying assembly 1, a cutting assembly 2, transfer assemblies 3 and a receiving assembly 4; the cutting assembly 2 is located on one side of a length direction of the conveying assembly 1; the transfer assemblies 3 and the receiving assembly 4 are located on the other side of the length direction of the conveying assembly 1; and the transfer assemblies 3 are capable of reciprocating in length and width directions of the conveying assembly 1.

It can be seen from the above-mentioned description that the beneficial effects of the present disclosure lie in that: provided is a fully-automatic multi-station cutting machine. After being conveyed to a specified position by the conveying assembly 1, a material can be uniformly cut into a plurality of segments by the cutting assembly 2. After the cutting is ended, a head or tail material is taken out of the conveying assembly 1 and is transferred to the receiving assembly 4 by the transfer assemblies, finally, the head or tail material is further withdrawn from the fully-automatic multi-station cutting machine by the receiving assembly 4, and thus, the fully-automatic cutting for the material can be completed.

Further, the conveying assembly 1 includes two roller frames 11 parallel to each other in the length direction; each of the roller frames 11 includes a driving motor and roller groups 111 uniformly distributed in a length direction of the roller frame 11; the roller groups 111 and the driving motor are driven and connected a chain; and the roller groups 111 on the two roller frames 11 are disposed oppositely. Specifically, the chain may be a roller chain, and the structure of the conveying assembly 1 may refer to a feeding mechanism of a multi-station cutting machine disclosed by Chinese Patent Publication CN112536929A.

It can be seen from the above-mentioned description that this design provides a structural support for the conveying assembly 1 capable of driving a material to be fed in the length direction of the conveying assembly 1.

Further, both ends of the conveying assembly 1 are provided with lifting devices 12; and
the lifting devices 12 are connected to the roller frames 11.

Further, the above-mentioned fully-automatic multi-station cutting machine further includes floating supporting members 5; and
the floating supporting members 5 are located between the two roller frames 11.

It can be seen from the above-mentioned description that after the material is moved to a specified position by the conveying assembly 1, the conveying assembly 1 drives the material to move downwards under the action of the lifting devices 12 until the material presses against the floating supporting members 5, and then, the cutting assembly 2 is started to cut the material. The material is moved up and down by the lifting devices 12, so that the cutting stability can be improved under the assistance of the floating supporting members 5, mutual interference between the cutting assembly 2 and the conveying assembly 1 during downward movement can be avoided, and at the same time, a gap between the conveying assembly 1 and the material can be enlarged by the operation of downward movement, and then, the transfer assemblies 3 can more smoothly move to the downsides of the head and tail materials to complete the getting of the head and tail materials.

Further, the floating supporting members 5 are capable of reciprocating in the length direction of the conveying assembly 1.

It can be seen from the above-mentioned description that after the cutting assembly 2 completes the cutting for the material, a gap at a breaking point is relatively small, which is not beneficial to the resetting of the cutting assembly 2. If the floating supporting members 5 are capable of reciprocating in the length direction of the conveying assembly 1, segmented materials may be driven to translate in order in the length direction of the conveying assembly 1 after the cutting is ended, so that a distance between the segmented materials is increased, then, a cutting device can smoothly return to an initial position to prepare for the next cutting.

Further, the cutting assembly 2 includes a horizontal driving member 21; the horizontal driving member 21 includes at least two horizontal movable ends 211; moving directions of the horizontal movable ends 211 are parallel to a conveying direction of the conveying assembly 1; the horizontal movable ends 211 are provided with vertical driving members 22; movable ends of the vertical driving members 22 are provided with cutting wire saws 221; moving directions of the movable ends of the vertical driving members 22 are perpendicular to the conveying direction of the conveying assembly 1; and cutting ends of the cutting wire saws 221 are disposed to face a conveying surface of the conveying assembly 1.

It can be seen from the above-mentioned description that the flexibility of the cutting assembly 2 can be effectively improved by this design, so that the cutting assembly 2 can cut segmented materials with any lengths as required and limit the number of the cutting wire saws 221 to provide a structural support for the cutting assembly 2 capable of carrying a plurality of cutting wire saws 221, thereby effectively increasing the overall cutting efficiency, and then, synchronously completing the cutting for the head and tail materials and a middle material.

Further, at least three floating supporting members 5 are provided.

It can be seen from the above-mentioned description that this design provides a structural support for the cutting machine capable of synchronously cutting the head and tail materials, that is, the head material, the middle material and the tail material can be effectively supported by the floating supporting members 5, so that the problem that the material tips over due to a nonuniform force during cutting is avoided.

Further, each of the floating supporting members 5 includes a supporting base 51 and at least four supporting columns 52 disposed on the supporting base 51; axes of the supporting columns 52 are perpendicular to a horizontal plane, and supporting surfaces of the supporting columns 52 are disposed to face a to-be-processed material; and the supporting columns 52 are juxtaposed one by one in an avoidance channel 14 in the conveying direction of the conveying assembly 1.

Further, each of the floating supporting members 5 further includes locking cylinders 53; fixed ends of the locking cylinders 53 are connected to the supporting base 51; movable ends of the locking cylinders 53 are connected to the supporting columns 52; and moving directions of the movable ends of the locking cylinders 53 are parallel to the axes of the supporting columns 52.

It can be seen from the above-mentioned description that by disposing the at least four supporting columns 52, each segment of segmented materials obtained after cutting can be reliably supported, so that the segmented materials are prevented from falling from the conveying assembly 1. By cooperation between each of the locking cylinders 53 and each of the supporting columns 52, the material can be actively supported by the supporting columns 52; and after the locking cylinders 53 are in contact with the material and a pressure reaches a specified value, the pressure stops raising, and at the same time, automatic locking is achieved to avoid the situation that an air cylinder is discharged to retract.

Further, each of the floating supporting members 5 further includes a horizontal driving device 54; a movable end of the horizontal driving device 54 is connected to the supporting base 51; and a moving direction of the movable end of the horizontal driving device 54 is parallel to the conveying direction of the conveying assembly 1. Specifically, the horizontal driving device 54 may be an air cylinder.

It can be seen from the above-mentioned description that by disposing the horizontal driving device 54, a structural support is provided for the floating supporting members 5 capable of reciprocating in the conveying direction of the conveying assembly 1.

Further, the above-mentioned fully-automatic multi-station cutting machine further includes a first driving member 13; each of the transfer assemblies 3 includes a second driving member 31 and a material transfer frame 32; the conveying assembly 1 and the second driving member 31 are driven and connected by the first driving member 13; the material transfer frame 32 is connected to a movable end of the second driving member 31; a moving direction of the first driving member 13 is parallel to the length direction of the conveying assembly 1; and a moving direction of the second driving member 31 is perpendicular to the length direction of the conveying assembly 1.

Further, each of the transfer assemblies 3 further includes a transverse moving device 34; the transverse moving device 34 is connected to the second driving member 31; the transverse moving device 34 includes a crawling assembly 341; the transverse moving device 34 and the first driving member 13 are driven and connected by the crawling assembly 341; and a moving direction of the crawling assembly 341 is parallel to an axis of a to-be-processed material. Specifically, the crawling assembly 341 may be any commercial equipment, such as a motor, with a driving effect. Existing transfer assemblies are matched with peripheral equipment by a rack 311, thereby achieving an effect of interaction with the peripheral equipment. Therefore, a movable end of the motor may be further provided with a gear to achieve an effect of engaging with the rack 311.

Further, the transverse moving device 34 further include a guide assembly 342; the guide assembly 342 and a movable end of the crawling assembly 341 are located on the same side of the transverse moving device 34; and the guide assembly 342 is slidably connected to the first driving member 13. Specifically, the guide assembly 342 may be a guide block, and a guide effect can be achieved in a way of cooperation between the guide block and a slide rail.

It can be seen from the above-mentioned description that due to the cooperation between the crawling assembly 341 and the guide assembly 342, the transverse moving device 34 may stably drive the transfer assemblies 3 to move in a direction parallel to the axis of the to-be-processed material.

Further, the second driving member 31 includes a rack 311, a transmission motor 312 and a driving gear 313; the rack 311 is parallel to the moving direction of the second driving member 31; and the transmission motor 312 and the rack 311 are driven and connected by the driving gear 313.

It can be seen from the above-mentioned description that this design provides a structural support for the second driving member 31 capable of driving the material transfer frame 32 to move in a direction perpendicular to the moving direction of the first driving member 13.

Further, the second driving member 31 further includes a driving cylinder 314; the material transfer frame 32 is connected to the second driving member 31 by a movable end of the driving cylinder 314; and a moving direction of the movable end of the driving cylinder 314 is parallel to the moving direction of the second driving member 31.

It can be seen from the above-mentioned description that a displacement distance of the second driving member 31 is limited, and therefore, after the second driving member 31 drives the material transfer frame 32 to move to a limit position of the second driving member 31, the driving cylinder 314 can further drive the material transfer frame 32 to move in the moving direction of the second driving member 31, so that an effect of increasing a moving distance of the material transfer frame 32 is achieved, and then, the head or tail material can be better received.

Further, the second driving member 31 further includes a guide slide rail 315 and a slide block 316; the slide block 316 is slidably connected to the guide slide rail 315; the material transfer frame 32 is slidably connected to the guide slide rail 315 by the slide block 316; and a length direction of the guide slide rail 315 is parallel to the moving direction of the movable end of the driving cylinder 314.

It can be seen from the above-mentioned description that due to the cooperation between the guide slide rail 315 and the slide block 316, the moving stability of the material transfer frame 32 can be improved, the phenomenon that the material transfer frame 32 skews and shakes during movement to affect the receiving of the head and tail materials is avoided.

Further, the material transfer frame 32 includes a first support frame 321, a second support frame 322 and a third support frame 323; and the first support frame 321, the second support frame 322 and the third support frame 323 form a trident structure.

It can be seen from the above-mentioned description that in order to ensure that the material transfer frame 32 can completely move to the downside of the head or tail material, that is, in order to avoid the mutual interference between the material transfer frame 32 and each of the floating supporting members 5, the material transfer frame 32 needs to be disposed to be of the trident structure, so that the supporting columns 52 on the floating supporting members 5 can smoothly move to a gap formed by the first support frame 321, the second support frame 322 and the third support frame 323, and then, the problem of interference is avoided.

Further, the second support frame 322 is located between the first support frame 321 and the third support frame 323; each of the first support frame 321 and the third support frame 323 is provided with a first supporting seat 324; and the second support frame 322 is provided with a second supporting seat 325.

Further, the first supporting seat 324 is higher than the second supporting seat 325.

It can be seen from the above-mentioned description that the first supporting seat 324 and the second supporting seat 325 can play a role in further supporting the head or tail material, and it is ensured that the first supporting seat 324 is higher than the second supporting seat 325, which can indirectly lower the center of gravity of the head or tail material, thereby effectively improving the stability of the head or tail material during transfer.

Further, each of the first support frame 321 and the third support frame 323 is further provided with a roller support frame 326; and a length direction of the roller support frame 326 is parallel to a length direction of the second support frame 322.

It can be seen from the above-mentioned description that when the head or tail material is withdrawn from the material transfer frame 32, the roller support frame 326 can effectively reduce a friction force generated by the head or tail material during movement, thereby facilitating the material pushing for the head or tail material.

Further, each of the transfer assemblies 3 further includes a material pushing device 33; a material pushing end of the material pushing device 33 is disposed towards an end, away from the second driving member 31, of the material transfer frame 32; and the material pushing device 33 is connected to the movable end of the second driving member 31 or an outer frame of the second driving member 31.

It can be seen from the above-mentioned description that by disposing the material transfer frame 32 and the material pushing device 33 which is connected to the movable end of the second driving member 31 or the outer frame of the second driving member 31 on the movable end of the second driving member 31, the material on the material transfer frame 32 can be quickly pushed out of the material transfer frame 32 by the material pushing device 33 after being got by the transfer assemblies 3, so that the overall working efficiency is increased.

The present disclosure further provides another material transfer frame 32, where the material transfer frame 32 is provided with at least two positioning bars 327; and axes of the positioning bars 327 are parallel to the moving direction of the material pushing device 33.

It can be seen from the above-mentioned description that due to the existence of the positioning bars 327, when the material falls on the material transfer frame 32, the stability of the material can be improved, and the phenomenon that the material shakes during transfer to slide out of the material transfer frame 32 is avoided.

Further, the positioning bars 327 are arranged in the moving direction of the material transfer frame 32; and a distance between each of the positioning bars 327 and the bottom of the material transfer frame 32 is gradually reduced from two ends to the middle in an arrangement direction.

It can be seen from the above-mentioned description that this design further limits a layout way of the positioning bars 327 and enables the plurality of positioning bars 327 to form a sunken structure which is high on two ends and low in the middle, so that a material with any size can be stably fixed on the material transfer frame 32.

Further, a moving end of the material pushing device 33 is provided with a material pushing plate 331; an end, close to the positioning bars 327, of the material pushing plate 331 is provided with an avoidance gap 332; and the shape of the avoidance gap 332 is consistent with the shape of an outer contour of each of the positioning bars 327.

It can be seen from the above-mentioned description that by disposing the material pushing plate 331, the contact area between the material pushing device 33 and the material can be increased, so that the stability during material pushing can be improved; and by disposing the avoidance gap 332, the phenomenon that the normal material pushing of the material pushing device 33 is affected by mutual interference between the material pushing plate 331 and each of the positioning bars 327 can be avoided.

Further, the material pushing device 33 is provided with a cover plate 333.

It can be seen from the above-mentioned description that a great number of cutting scraps can be generated during material cutting, the cover plate 333 can be disposed to play a certain blocking role and avoid the phenomenon that the cutting scraps are accumulated in a gap of the material pushing device 33 to affect the normal material pushing of the material pushing device 33.

Further, the material transfer frame 32 is further provided with an avoidance groove 328.

It can be seen from the above-mentioned description that this design also plays a role in avoiding the situation of mutual interference between the material transfer frame 32 and each of the floating supporting members 5.

Further, the receiving assembly 4 includes a third driving member 41 and receiving baskets 42; the receiving baskets 42 are connected to a movable end of the third driving member 41; a moving direction of the third driving member 41 is perpendicular to the conveying direction of the conveying assembly 1; and two ends, parallel to the length direction of the conveying assembly 1, of the receiving baskets 42 are provided with feeding holes.

It can be seen from the above-mentioned description that structures of the transfer assemblies 3 and the receiving assembly 4 are further limited, so that the transfer assemblies 3 and the receiving assembly 4 can achieve automatic receiving and automatic dumping, and then, the overall processing efficiency can be obviously increased.

Further, two transfer assemblies 3 are provided; the receiving assembly 4 is located between the two transfer assemblies 3; and the feeding holes in two ends of the receiving baskets 42 are respectively located within movement ranges of the corresponding material transfer frames 32. Specifically, two sides of the length direction of the receiving basket 42 are provided with fences; and gaps between the same ends in length directions of the fences form the feeding holes.

It can be seen from the above-mentioned description that this design provides a structural support for the transfer assemblies 3 capable of dumping the head and tail materials in order.

Further, the receiving assembly 4 further includes a lifting mechanism 43; and the receiving baskets 42 are connected to the third driving member 41 by the lifting mechanism 43.

It can be seen from the above-mentioned description that the lifting mechanism 43 can improve the longitudinal flexibility of the receiving assembly 4, so that the receiving baskets 42 can actively receive the material in the material transfer frame 32, and then, the material transfer efficiency is increased.

Further, the lifting mechanism 43 includes a bottom plate 4301, a connecting frame 4302 and at least two first power cylinders 4303; the bottom plate 4301 is connected to the movable end of the third driving member 41 by the connecting frame 4302; and bottoms of the receiving baskets 42 are connected to the bottom plate 4301 by the first power cylinders 4303.

Further, the above-mentioned lifting mechanism 43 further includes first guide rods 4304; and the bottoms of the receiving baskets 42 are connected to the bottom plate 4301 by the first guide rods 4304.

Further, the bottom plate 4301 is provided with first buffers 4305; and buffering ends of the first buffers 4305 are disposed to face the bottoms of the receiving baskets 42.

Further, the bottom plate 4301 is further provided with a through hole 4306 and a first buffer frame 4307; the bottoms of the receiving baskets 42 are provided with a second buffer frame 4308; the second buffer frame 4308 is capable of passing through the through hole 4306 to synchronously move with the first power cylinders 4303; a limit surface of the first buffer frame 4307 is disposed to be opposite to a limit surface of the second buffer frame 4308; the limit surface of the second buffer frame 4308 is provided with a buffer member 4309; and a buffering end of the buffer member 4309 is disposed to face the receiving baskets 42.

It can be seen from the above-mentioned description that this design provides a structural support for the lifting mechanism 43 capable of driving the receiving baskets 42 to lift, and the first power cylinders 4303 provides core driving forces for the lifting mechanism 43; the first guide rods 4304 can avoid shaking and skewing of the receiving baskets 42 during lifting, so that the material receiving stability is improved; when moving speeds of the receiving baskets 42 are overhigh, the first buffers 4305 can avoid a situation that the bottom plate 4301 is broken by an excessively great impact force; and due to the cooperation between the first buffer frame 4307 and the second buffer frame 4308, equipment can be buffered and limited when the receiving baskets 42 are lifted, and the problem of mutual interference between each of the receiving baskets 42 and each of the transfer assemblies 3 due to an overlong moving distance when the receiving baskets 42 receive the material in the transfer assemblies 3 is avoided.

The present disclosure further provides another lifting mechanism 43 including a support plate 4310, a movable buffer frame 4311 and a second power cylinder 4312; the support plate 4310 is connected to the movable end of the third driving member 41 by the second power cylinder 4312; the bottoms of the receiving baskets 42 are connected to a movable end of the second power cylinder 4312; the support plate 4310 sleeves the outside of the movable buffer frame 4311; and one end of the movable buffer frame 4311 is connected to the bottoms of the receiving baskets 42, and the other end thereof is provided with a limit block 4313.

Further, the above-mentioned lifting mechanism 43 further includes second guide rods 4314; and the bottoms of the receiving baskets 42 are slidably connected to the support plate 4310 by the second guide rods 4314.

Further, the support plate 4310 is provided with a second buffer 4315 and a third buffer 4316; a buffering end of the second buffer 4315 is disposed to face the bottoms of the receiving baskets 42; and a buffering end of the third buffer 4316 is disposed to face the limit block 4313.

It can be seen from the above-mentioned description that this design provides another lifting mechanism 43, the second power cylinder 4312 synchronously drives the receiving baskets 42 and the movable buffer frame 4311 to move, and when the bottoms of the receiving baskets 42 and the limit block 4313 on the movable buffer frame 4311 are respectively in contact with the second buffer 4315 and the third buffer 4316, effects of buffering and vertically limiting the receiving baskets 42 can be achieved; and the second guide rods 4314 can also avoid shaking and skewing of the receiving baskets 42 during lifting, so that the material receiving stability is improved.

Further, two ends, perpendicular to the moving direction of the third driving member 41, of the receiving baskets 42 are provided with backstop devices 44.

Further, each of the backstop devices 44 includes a backstop cylinder and a limit column; a fixed end of the backstop cylinder is connected to the receiving basket 42; a movable end of the backstop cylinder is connected to the limit column; and a moving direction of the backstop cylinder and an axis of the limit column are both perpendicular to a horizontal plane.

It can be seen from the above-mentioned description that after head and tail materials are transferred into the receiving baskets 42 by the transfer assemblies 3, the backstop devices 44 are started to extend into the transfer assemblies 3 to play a role in limiting ends of remaining materials, thereby avoiding taking the remaining materials out of the receiving baskets 42 again when the transfer assemblies 3 are withdrawn.

Further, ends, perpendicular to the moving direction of the third driving member 41, of the receiving baskets 42 are open ends, and the other ends are closed ends; and juxtaposed supporting beams 421 are disposed on the bottoms of the receiving baskets 42.

It can be seen from the above-mentioned description that when a material is transferred into the receiving baskets 42 by the transfer assemblies 3, the lifting mechanism 43 drives the receiving baskets 42 to lift until the supporting beams 421 eject the material, so that the material can be separated from the transfer assemblies 3, then, not only can the material be stably transferred into the receiving baskets 42, but also the material can be prevented from being taken out of the receiving baskets 42 again when the transfer assemblies 3 are withdrawn from the receiving baskets 42.

Further, at least two receiving baskets 42 are provided; the closed ends of the two receiving baskets 42 cling to each other; and open ends of the receiving baskets 42 are disposed to face the corresponding backstop devices 44.

It can be seen from the above-mentioned description that by disposing the two receiving baskets 42 with the closed ends clinging to each other, a structural support for the receiving assembly 4 capable of receiving head and tail materials at the same time is provided, so that the head and tail materials can be withdrawn once, and then, the working efficiency of the receiving assembly 4 is increased.

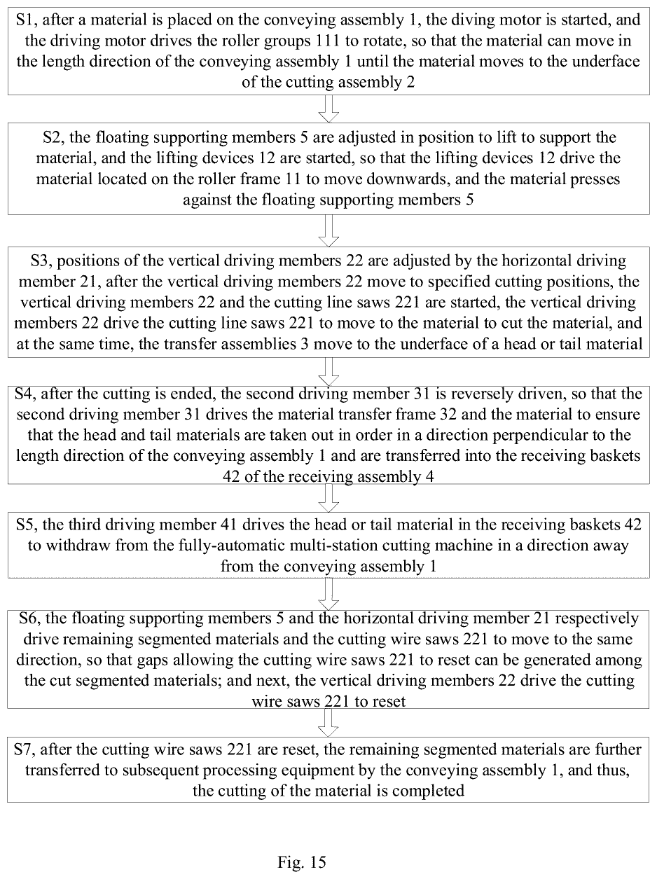

As shown in FIG. 15, the present disclosure further provides a method for cutting a material by adopting the above-mentioned fully-automatic multi-station cutting machine, including the following steps:
S1, after a material is placed on the conveying assembly 1, the diving motor is started, and the driving motor drives the roller groups 111 to rotate, so that the material can move in the length direction of the conveying assembly 1 until the material moves to the underface of the cutting assembly 2;
S2, the floating supporting members 5 are adjusted in position to lift to support the material, and the lifting devices 12 are started, so that the lifting devices 12 drive the material located on the roller frame 11 to move downwards, and the material presses against the floating supporting members 5;
S3, positions of the vertical driving members 22 are adjusted by the horizontal driving member 21, after the vertical driving members 22 move to specified cutting positions, the vertical driving members 22 and the cutting line saws 221 are started, the vertical driving members 22 drive the cutting line saws 221 to move to the material to cut the material, and at the same time, the transfer assemblies 3 move to the underface of a head or tail material;
S4, after the cutting is ended, the second driving member 31 is reversely driven, so that the second driving member 31 drives the material transfer frame 32 and the material to ensure that the head and tail materials are taken out in order in a direction perpendicular to the length direction of the conveying assembly 1 and are transferred into the receiving baskets 42 of the receiving assembly 4;
S5, the third driving member 41 drives the head or tail material in the receiving baskets 42 to withdraw from the fully-automatic multi-station cutting machine in a direction away from the conveying assembly 1;
S6, the floating supporting members 5 and the horizontal driving member 21 respectively drive remaining segmented materials and the cutting wire saws 221 to move to the same direction, so that gaps allowing the cutting wire saws 221 to reset can be generated among the cut segmented materials; and next, the vertical driving members 22 drive the cutting wire saws 221 to reset; and
S7, after the cutting wire saws 221 are reset, the remaining segmented materials are further transferred to subsequent processing equipment by the conveying assembly 1, and thus, the cutting of the material is completed.

It can be seen from the above-mentioned description that the fully-automatic multi-station cutting machine provides a structural support for the automatic cutting for the material, and due to the cooperation among the automatic equipment in the above-mentioned steps, automatic feeding, cutting and dumping functions can be achieved in order, so that the labor cost is reduced while the overall cutting efficiency is increased.

The fully-automatic multi-station cutting machine in the present disclosure can assist in the segmented cutting of the material, and is especially suitable for the segmented cutting of silicon rods.

Please refer to FIG. 1 to FIG. 7, a first embodiment of the present disclosure is described as follows.

A fully-automatic multi-station cutting machine includes a conveying assembly 1, a cutting assembly 2, a receiving assembly 4, a first driving member 13, floating supporting members 5 and two transfer assemblies 3; the cutting assembly 2 is located on one side of a length direction of the conveying assembly 1; the transfer assemblies 3 and the receiving assembly 4 are located on the other side of the length direction of the conveying assembly 1; each of the transfer assemblies 3 includes a second driving member 31, a material transfer frame 32 and a transverse moving device 34; the transverse moving device 34 includes a crawling assembly 341 and a guide assembly 342; the transverse moving device 34 is connected to the second driving member 31; the guide assembly 342 and a movable end of the crawling assembly 341 are located on the same side of the transverse moving device 34; the transverse moving device 34 and the first driving member 13 are driven and connected by the crawling assembly 341; a moving direction of the crawling assembly 341 is parallel to an axis of a to-be-processed material; the guide assembly 342 is slidably connected to the first driving member 13; the material transfer frame 32 is connected to a movable end of the second driving member 31; a moving direction of the first driving member 13 is parallel to the length direction of the conveying assembly 1; and a moving direction of the second driving member 31 is perpendicular to the length direction of the conveying assembly 1; the second driving member 31 includes a rack 311, a transmission motor 312, a driving gear 313, a driving cylinder 314, a guide slide rail 315 and a slide block 316; the rack 311 is parallel to the moving direction of the second driving member 31; the transmission motor 312 and the rack 311 are driven and connected by the driving gear 313; the material transfer frame 32 is connected to the second driving member 31 by a movable end of the driving cylinder 314; a moving direction of the movable end of the driving cylinder 314 is parallel to the moving direction of the second driving member 31; the slide block 316 is slidably connected to the guide slide rail 315; the material transfer frame 32 is slidably connected to the guide slide rail 315 by the slide block 316; a length direction of the guide slide rail 315 is parallel to the moving direction of the movable end of the driving cylinder 314; the material transfer frame 32 includes a first support frame 321, a second support frame 322 and a third support frame 323; the first support frame 321, the second support frame 322 and the third support frame 323 form a trident structure; the second support frame 322 is located between the first support frame 321 and the third support frame 323; each of the first support frame 321 and the third support frame 323 is provided with a first supporting seat 324; the second support frame 322 is provided with a second supporting seat 325; the first supporting seat 324 is higher than the second supporting seat 325; each of the first support frame 321 and the third support frame 323 is further provided with a roller support frame 326; and a length direction of the roller support frame 326 is parallel to a length direction of the second support frame 322.

The receiving assembly 4 includes a third driving member 41, backstop devices 44 and two receiving baskets 42; the receiving baskets 42 are connected to a movable end of the third driving member 41; a moving direction of the third driving member 41 is perpendicular to the conveying direction of the conveying assembly 1; ends, perpendicular to the moving direction of the third driving member 41, of the receiving baskets 42 are open ends, and the other ends are closed ends; juxtaposed supporting beams 421 are disposed on the bottoms of the receiving baskets 42; the closed ends of the two receiving baskets 42 cling to each other; open ends of the receiving baskets 42 are disposed to face the corresponding backstop devices 44; the receiving assembly 4 is located between the two transfer assemblies 3; the open ends on two ends of the receiving baskets 42 are respectively located within movement ranges of the corresponding material transfer frames 32; each of the backstop devices 44 includes a backstop cylinder and a limit column; a fixed end of the backstop cylinder is connected to the receiving basket 42; a movable end of the backstop cylinder is connected to the limit column; and a moving direction of the backstop cylinder and an axis of the limit column are both perpendicular to a horizontal plane.

The conveying assembly 1 includes two roller frames 11 parallel to each other in the length direction; each of the roller frames 11 includes a driving motor (undrawn in the figures) and roller groups 111 uniformly distributed in a length direction of the roller frame 11; the roller groups 111 and the driving motor are driven and connected by a chain; the roller groups 111 on the two roller frames 11 are disposed oppositely; both ends of the conveying assembly 1 are provided with lifting devices 12; the lifting devices 12 are connected to the roller frames 11; eight floating supporting members 5 are disposed between the two roller frames 11; each of the floating supporting members 5 includes a supporting base 51, locking cylinders 53, a horizontal driving devices 54 and four supporting columns 52 disposed on the supporting base 51; axes of the supporting columns 52 are perpendicular to a horizontal plane, and supporting surfaces of the supporting columns 52 are disposed to face a to-be-processed material; the supporting columns 52 are juxtaposed one by one in an avoidance channel 14 in the conveying direction of the conveying assembly 1; fixed ends of the locking cylinders 53 are connected to the supporting base 51; movable ends of the locking cylinders 53 are connected to the supporting columns 52; moving directions of the movable ends of the locking cylinders 53 are parallel to the axes of the supporting columns 52; a movable end of the horizontal driving device 54 is connected to the supporting base 51; and a moving direction of the movable end of the horizontal driving device 54 is parallel to the conveying direction of the conveying assembly 1.

The cutting assembly 2 includes a horizontal driving member 21; the horizontal driving member 21 includes seven horizontal movable ends 211; moving directions of the horizontal movable ends 211 are parallel to a conveying direction of the conveying assembly 1; the horizontal movable ends 211 are provided with vertical driving members 22; movable ends of the vertical driving members 22 are provided with cutting wire saws 221; moving directions of the movable ends of the vertical driving members 22 are perpendicular to the conveying direction of the conveying assembly 1; and cutting ends of the cutting wire saws 221 are disposed to face a conveying surface of the conveying assembly 1.

A second embodiment of the present disclosure is described as follows.

A method for cutting a material by adopting the above-mentioned fully-automatic multi-station cutting machine includes the following steps:
S1, after a material is placed on the conveying assembly 1, the diving motor is started, and the driving motor drives the roller groups 111 to rotate, so that the material can move in the length direction of the conveying assembly 1 until the material moves to the underface of the cutting assembly 2;
S2, the floating supporting members 5 are adjusted in position to lift to support the material, and the lifting devices 12 are started, so that the lifting devices 12 drive the material located on the roller frame 11 to move downwards, and the material presses against the floating supporting members 5;
S3, positions of the vertical driving members 22 are adjusted by the horizontal driving member 21, after the vertical driving members 22 move to specified cutting positions, the vertical driving members 22 and the cutting line saws 221 are started, the vertical driving members 22 drive the cutting line saws 221 to move to the material to cut the material, and at the same time, the transfer assemblies 3 move to the underface of a head or tail material;
S4, after the cutting is ended, the second driving member 31 is reversely driven, so that the second driving member 31 drives the material transfer frame 32 and the material to ensure that the head and tail materials are taken out in order in a direction perpendicular to the length direction of the conveying assembly 1 and are transferred into the receiving baskets 42 of the receiving assembly 4;
S5, the third driving member 41 drives the head or tail material in the receiving baskets 42 to withdraw from the fully-automatic multi-station cutting machine in a direction away from the conveying assembly 1;
S6, the floating supporting members 5 and the horizontal driving member 21 respectively drive remaining segmented materials and the cutting wire saws 221 to move to the same direction, so that gaps allowing the cutting wire saws 221 to reset can be generated among the cut segmented materials; and next, the vertical driving members 22 drive the cutting wire saws 221 to reset; and
S7, after the cutting wire saws 221 are reset, the remaining segmented materials are further transferred to subsequent processing equipment by the conveying assembly 1, and thus, the cutting of the material is completed.

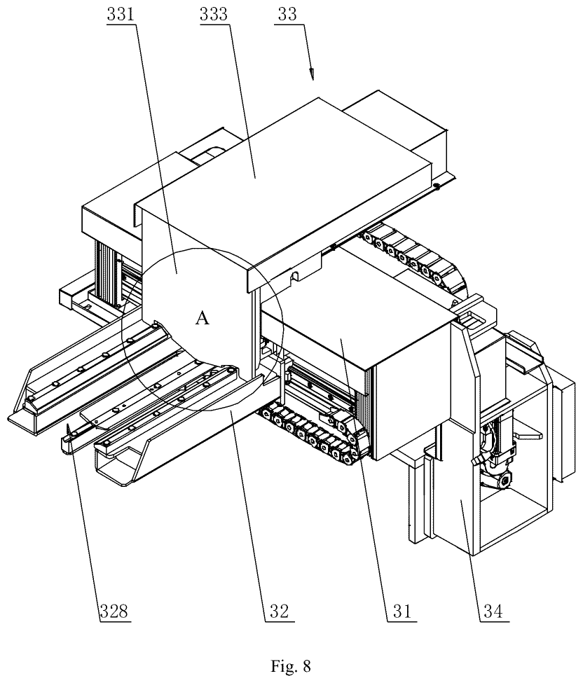

Refer to FIG. 8 to FIG. 10, a third embodiment of the present disclosure differs from the first embodiment in that: each of the transfer assemblies 3 further includes a material pushing device 33; a material pushing end of the material pushing device 33 is disposed towards an end, away from the second driving member 31, of the material transfer frame 32; the material pushing device 33 is connected to the movable end of the second driving member 31 or an outer frame of the second driving member 31; the material transfer frame 32 is provided with three positioning bars 327; axes of the positioning bars 327 are parallel to the moving direction of the material pushing device 33; the positioning bars 327 are arranged in the moving direction of the material transfer frame 32; a distance between each of the positioning bars 327 and the bottom of the material transfer frame 32 is gradually reduced from two ends to the middle in an arrangement direction; a moving end of the material pushing device 33 is provided with a material pushing plate 331; an end, close to the positioning bars 327, of the material pushing plate 331 is provided with an avoidance gap 332; the shape of the avoidance gap 332 is consistent with the shape of an outer contour of each of the positioning bars 327; the material pushing device 33 is provided with a cover plate 333; the material transfer frame 32 is further provided with an avoidance groove 328; and the open ends of the receiving baskets 42 are not provided with the backstop devices 44.

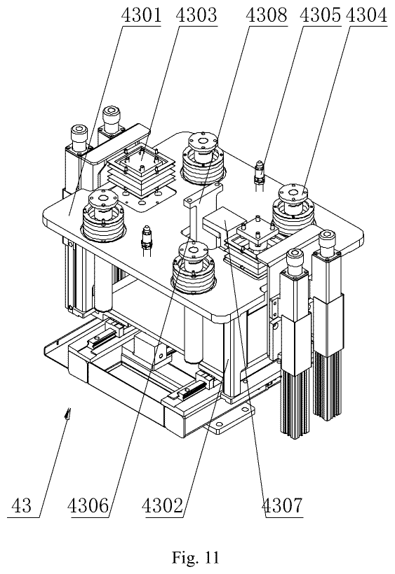

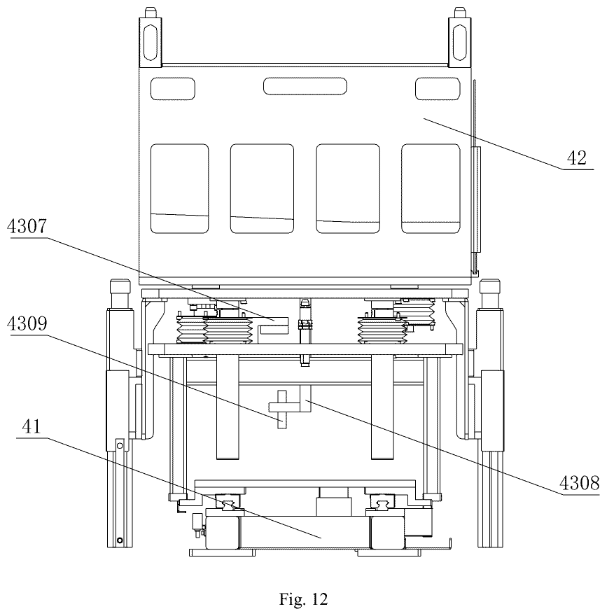

Refer to FIG. 11 to FIG. 12, a fourth embodiment of the present disclosure differs from the first embodiment in that: the receiving assembly 4 further includes a lifting mechanism 43; the receiving baskets 42 are connected to the third driving member 41 by the lifting mechanism 43; the lifting mechanism 43 includes a bottom plate 4301, a connecting frame 4302, first guide rods 4304 and two first power cylinders 4303; the bottom plate 4301 is connected to the movable end of the third driving member 41 by the connecting frame 4302; bottoms of the receiving baskets 42 are connected to the bottom plate 4301 by the first power cylinders 4303; the bottoms of the receiving baskets 42 are connected to the bottom plate 4301 by the first guide rods 4304; the bottom plate 4301 is provided with first buffers 4305, a through hole 4306 and a first buffer frame 4307; buffering ends of the first buffers 4305 are disposed to face the bottoms of the receiving baskets 42; the bottoms of the receiving baskets 42 are provided with a second buffer frame 4308; the second buffer frame 4308 is capable of passing through the through hole 4306 to synchronously move with the first power cylinders 4303; a limit surface of the first buffer frame 4307 is disposed to be opposite to a limit surface of the second buffer frame 4308; the limit surface of the second buffer frame 4308 is provided with a buffer member 4309; and a buffering end of the buffer member 4309 is disposed to face the receiving baskets 42.

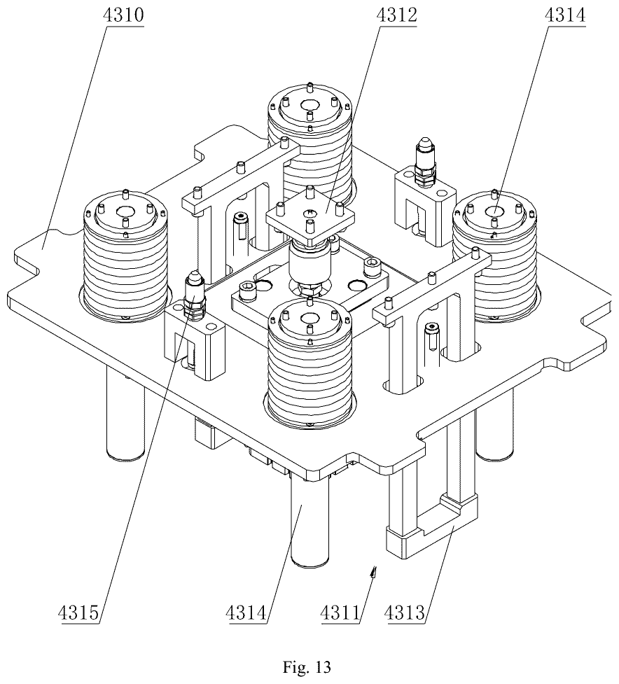

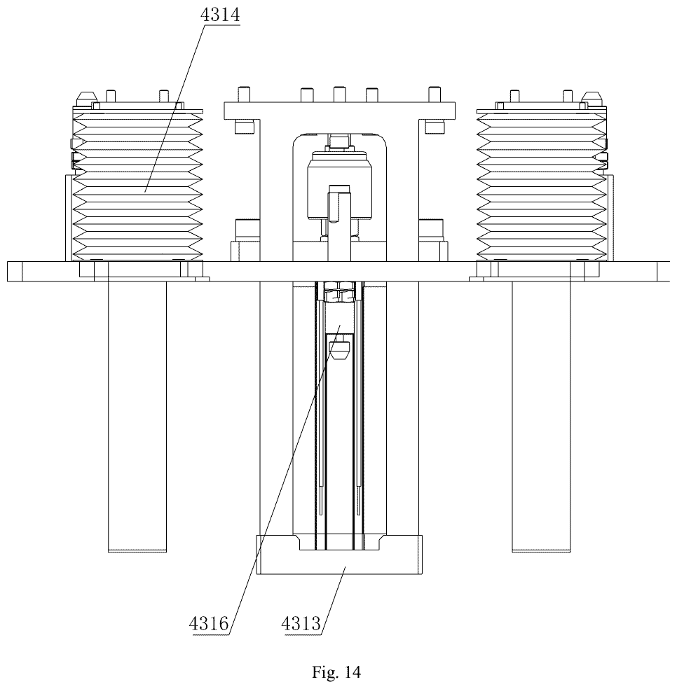

Refer to FIG. 13 to FIG. 14, a fifth embodiment of the present disclosure differs from the fourth embodiment in that: provided is another lifting mechanism 43 including a support plate 4310, a movable buffer frame 4311, a second power cylinder 4312 and second guide rods 4314; the support plate 4310 is connected to the movable end of the third driving member 41 by the second power cylinder 4312; the bottoms of the receiving baskets 42 are connected to a movable end of the second power cylinder 4312; the support plate 4310 sleeves the outside of the movable buffer frame 4311; one end of the movable buffer frame 4311 is connected to the bottoms of the receiving baskets 42, and the other end thereof is provided with a limit block 4313; the bottoms of the receiving baskets 42 are slidably connected to the support plate 4310 by the second guide rods 4314; the support plate 4310 is provided with a second buffer 4315 and a third buffer 4316; a buffering end of the second buffer 4315 is disposed to face the bottoms of the receiving baskets 42; and a buffering end of the third buffer 4316 is disposed to face the limit block 4313.

The working principle of the present disclosure is described as follows.

Firstly, after the material is placed on the conveying assembly 1 by peripheral feeding equipment, the diving motor is started, and the driving motor drives the roller groups 111 to rotate, so that the material can move in the length direction of the conveying assembly 1 until the material moves to the underface of the cutting assembly 2; then, positions of the floating supporting members 5 are adjusted by the horizontal driving device 54, and the lifting devices 12 and the locking cylinders are started, so that the lifting devices 12 drive the material located on the roller frame 11 to move downwards, before descending, the locking cylinders 53 also drive the supporting columns 52 to lift to press against the material, and finally the material presses against the floating supporting members 5; next, positions of the vertical driving members 22 are adjusted by the horizontal driving member 21, after the vertical driving members 22 move to specified cutting positions, the vertical driving members 22 and the cutting line saws 221 are started, the vertical driving members 22 drive the cutting line saws 221 to move to the material to cut the material; and before cutting or during cutting, the transmission motor 312 drives the driving gear 313 to rotate, so that the second driving member 31 drives the material transfer frame 32 to be close to the material in a direction perpendicular to the axis of the material under the cooperation of the driving gear 313 and the rack 311, if the avoidance groove 328 in the material transfer frame 32 cannot overlap with the supporting columns 52, the driving cylinder 314 further drives the material transfer frame 32 to move in the guide rail until the avoidance groove 328 overlap with the supporting columns 52, and then, the crawling assembly 341 and the guide assembly 342 on the transverse moving device 34 drive the material transfer frame 32 to move to the head or tail material until the supporting columns 52 extend into the avoidance groove 328 of the material transfer frame 32, so that the material transfer frame 32 can be located under the head or tail material; after the cutting is ended, the transmission motor 312 and the driving cylinder 314 are reversely driven, so that the second driving member 31 drives the head or tail material to be taken out in order in a direction perpendicular to the axis of the material and to be transferred into the receiving baskets 42 of the receiving assembly 4, and the third driving member 41 drives the head or tail material in the receiving baskets 42 to withdraw from fully-automatic multi-station cutting machine; then, the floating supporting members 5 and the horizontal driving member 21 respectively drive remaining segmented materials and the cutting wire saws 221 to move to the same direction, so that gaps allowing the cutting wire saws 221 to reset can be generated among the cut segmented materials; and next, the vertical driving members 22 drive the cutting wire saws 221 to reset; and finally, the remaining segmented materials are further transferred to subsequent processing equipment by the conveying assembly 1, and thus, the cutting of the material is completed.

In conclusion, the fully-automatic multi-station cutting machine provided in the present disclosure is compact in structure and convenient to use. After being conveyed to a specified position by the conveying assembly, a material can be uniformly cut into a plurality of segments by the cutting assembly. After the cutting is ended, a head or tail material is taken out of the conveying assembly and is transferred to the receiving assembly by the transfer assemblies, finally, the head or tail material is further withdrawn from the fully-automatic multi-station cutting machine by the receiving assembly, and thus, the fully-automatic cutting for the material can be completed.

The above-mentioned description is only intended to show the embodiments of the present disclosure, rather than to hence limit the patent scope of the present disclosure. All equivalent transformations made according to the contents in the description and accompanying drawings of the present disclosure are directly or indirectly applied to the relevant technical fields and also fall within the patent protection scope of the present disclosure.

What is claimed is:

1. A fully-automatic multi-station cutting machine, comprising a conveying assembly, a cutting assembly, transfer assemblies and a receiving assembly;
the cutting assembly being located on one side of a length direction of the conveying assembly;
the transfer assemblies and the receiving assembly being located on the other side of the length direction of the conveying assembly; and
the transfer assemblies being capable of reciprocating in length and width directions of the conveying assembly.

2. The fully-automatic multi-station cutting machine according to claim 1, wherein the conveying assembly comprises two roller frames parallel to each other in the length direction;
each of the roller frames comprises a driving motor and roller groups uniformly distributed in a length direction of the roller frame;
the roller groups and the driving motor are driven and connected by a chain; and
the roller groups on the two roller frames are disposed oppositely.

3. The fully-automatic multi-station cutting machine according to claim 2, wherein both ends of the conveying assembly are provided with lifting devices; and
the lifting devices are connected to the roller frames.

4. The fully-automatic multi-station cutting machine according to claim 2, further comprising floating supporting members; and
the floating supporting members being located between the two roller frames.

5. The fully-automatic multi-station cutting machine according to claim 4, wherein the floating supporting members are capable of reciprocating in the length direction of the conveying assembly.

6. The fully-automatic multi-station cutting machine according to claim 1, wherein the cutting assembly comprises a horizontal driving member;
the horizontal driving member comprises at least two horizontal movable ends;
moving directions of the horizontal movable ends are parallel to a conveying direction of the conveying assembly;
the horizontal movable ends are provided with vertical driving members;
movable ends of the vertical driving members are provided with cutting wire saws;
moving directions of the movable ends of the vertical driving members are perpendicular to the conveying direction of the conveying assembly; and
cutting ends of the cutting wire saws are disposed to face a conveying surface of the conveying assembly.

7. The fully-automatic multi-station cutting machine according to claim 4, wherein at least three floating supporting members are provided.

8. The fully-automatic multi-station cutting machine according to claim 7, wherein each of the floating supporting members comprises a supporting base and at least four supporting columns disposed on the supporting base;
axes of the supporting columns are perpendicular to a horizontal plane, and supporting surfaces of the supporting columns are disposed to face a to-be-processed material; and
the supporting columns are juxtaposed one by one in an avoidance channel in the conveying direction of the conveying assembly.

9. The fully-automatic multi-station cutting machine according to claim 8, wherein each of the floating supporting members further comprises locking cylinders;
fixed ends of the locking cylinders are connected to the supporting base;
movable ends of the locking cylinders are connected to the supporting columns; and
moving directions of the movable ends of the locking cylinders are parallel to the axes of the supporting columns.

10. The fully-automatic multi-station cutting machine according to claim 1, further comprising a first driving member;
each of the transfer assemblies comprising a second driving member and a material transfer frame;
the conveying assembly and the second driving member being driven and connected by the first driving member;
the material transfer frame being connected to a movable end of the second driving member;
a moving direction of the first driving member being parallel to the length direction of the conveying assembly; and
a moving direction of the second driving member being perpendicular to the length direction of the conveying assembly.

11. The fully-automatic multi-station cutting machine according to claim 10, wherein the second driving member comprises a rack, a transmission motor and a driving gear;
the rack is parallel to the moving direction of the second driving member; and
the transmission motor and the rack are driven and connected by the driving gear.

12. The fully-automatic multi-station cutting machine according to claim 10, wherein the second driving member further comprises a driving cylinder;
the material transfer frame is connected to the second driving member by a movable end of the driving cylinder; and
a moving direction of the movable end of the driving cylinder is parallel to the moving direction of the second driving member.

13. The fully-automatic multi-station cutting machine according to claim 12, wherein the second driving member further comprises a guide slide rail and a slide block;
the slide block is slidably connected to the guide slide rail;
the material transfer frame is slidably connected to the guide slide rail by the slide block; and
a length direction of the guide slide rail is parallel to the moving direction of the movable end of the driving cylinder.

14. The fully-automatic multi-station cutting machine according to claim 10, wherein each of the transfer assemblies further comprises a material pushing device;
a material pushing end of the material pushing device is disposed towards an end, away from the second driving member, of the material transfer frame; and
the material pushing device is connected to the movable end of the second driving member or an outer frame of the second driving member.

15. The fully-automatic multi-station cutting machine according to claim 10, wherein the receiving assembly comprises a third driving member and receiving baskets;
the receiving baskets are connected to a movable end of the third driving member;
a moving direction of the third driving member is perpendicular to the conveying direction of the conveying assembly; and
two ends, parallel to the length direction of the conveying assembly, of the receiving baskets are provided with feeding holes.

16. The fully-automatic multi-station cutting machine according to claim 15, wherein the receiving assembly further comprises a lifting mechanism; and
the receiving baskets are connected to the third driving member by the lifting mechanism.

17. The fully-automatic multi-station cutting machine according to claim 15, wherein two ends, perpendicular to the moving direction of the third driving member, of the receiving baskets are provided with backstop devices.

18. The fully-automatic multi-station cutting machine according to claim 17, wherein ends, perpendicular to the moving direction of the third driving member, of the receiving baskets are open ends, and the other ends are closed ends; and
juxtaposed supporting beams are disposed on the bottoms of the receiving baskets.

19. The fully-automatic multi-station cutting machine according to claim 18, wherein at least two receiving baskets are provided;
the closed ends of the two receiving baskets cling to each other; and
open ends of the receiving baskets are disposed to face the corresponding backstop devices.

20. A method for cutting a material by adopting the fully-automatic multi-station cutting machine according to claim 1, comprising the following steps:
S1, moving the material to an underface of the cutting assembly by the conveying assembly;
S2, after the cutting assembly moves to a specified cutting position, starting the cutting assembly to cut the material, and moving the transfer assemblies to an underface of a head or tail material;
S3, after the cutting is ended, transferring the head or tail material to the receiving assembly by the transfer assemblies, and resetting the cutting assembly; and
S4, withdrawing the head or tail material from the fully-automatic multi-station cutting machine by the receiving assembly to complete the cutting of the material.
